(19) United States
(12) Patent Application Publication
(10) Pub. No.: US 2003/0234729 A1
(43) Pub. Date: Dec. 25, 2003

(54) Power extension cable with loading indication and warning

(76) Inventor: Wu-Cheng Shen, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,578

(22) Filed: Jul. 29, 2002

(30) Foreign Application Priority Data
Jun. 20, 2002 (TW) 91209234

(51) Int. Cl. G08B 21/00

(52) U.S. Cl. 340/664

(57) ABSTRACT

A power extension cable with a loading indication and warning system. The power extension cable uses the loading indication and warning system to detect size of loading current passing through the extension cable. When the loading current passing though the extension cable exceeds a preset warning level, a warning message is issued so that a user may redistribute the loads before overloading the power extension cable to the breaking point.

### CROSS REFERENCE TO RELATED APPLICATIONS

This application claims the priority benefit of Taiwan application serial no. 91209234, filed Jun. 20, 2002.

### BACKGROUND OF INVENTION

1. Field of Invention

The present invention relates to a power extension cable. More particularly, the present invention relates to a power extension cable with loading indication and warning.

2. Description of Related Art

Ever since the discovery of usefulness of electricity, electric power has been used almost everywhere. Electricity is often the main source of power for lighting fixtures and many of our electronic appliances. The convenience and operational efficiency is unmatched by other sources of power. Equipment that uses electricity is all around us. Inside households, for example, televisions, hi-fi and video equipments, electric fans, air conditioners, microwaves and electric ovens all use electricity. To supply necessary electricity to the household equipment, a sufficient number of power sockets must be installed. Sometimes, however, the number of power sockets is smaller than the number of electrical appliances requiring electric power or the location of the appliances is too far away from the fixed outlet socket. In this case, an extension cable is often used to provide the number of extra sockets necessary for plugging the electrical appliances.

Following rapid economic improvement, most families have more than a few electronic products at home. To support all these electrical appliances, a variable number of power sockets are often provided through an extension cable. Yet, a conventional power extension does not have any loading indication and warning. The only safety feature available to a power extension cable is a cut-off fuse that trips when there is a current overload. Although the electrical appliance plugged to the extension cable is protected, a user has no way of assessing the current loading situation.

### SUMMARY OF INVENTION

Accordingly, one object of the present invention is to provide a power extension cable with loading indication and warning so that a warning signal is emitted when the loading current exceeds a preset warning level. Hence, a user may assess the degree of overloading and determine if the loading needs to be distributed.

To achieve these and other advantages and in accordance with the purpose of the invention, as embodied and broadly described herein, the invention provides a power extension cable with loading indication and warning that includes a conventional power extension cable and a loading indication warning system. The conventional power extension cable has at least a power socket for providing a current to an electrical appliance. The loading indication and warning system detects size of current flowing to the load. When the detected loading current exceeds a preset warning level, an alarm signal is triggered warning the user.

In one embodiment of this invention, the loading indication and warning system further includes a current detector, a current/voltage converter, a comparator and an alarm unit. The current detector gauges the size of the loading current and outputs a monitor current. The current/voltage converter is coupled to the current detector for receiving the monitor current and converting the monitor current into a monitor voltage. The comparator is coupled to the current/voltage converter for comparing the monitor voltage with a preset warning voltage and outputting a warning signal. The alarm unit is coupled to the comparator for receiving the warning signal and generating a warning message.

The current detector is preferably made up of a primary electric coil on one side of an iron core and a secondary electric coil on the other side of the iron core. Moreover, the number of turns in the primary electric coil connected to the power extension cable is smaller than the number of turns in the secondary electric coil.

The warning message is preferably a visual message provided by a light-emitting diode or an acoustic message provided by a buzzer. Alternatively, the preset warning level is divided into a few sections so that each section is indicated by the appearance of a warning message from a light-emitting diode in that section. When the loading current reaches the highest preset warning level, the buzzer also emits a sound to alarm the user about this condition.

In brief, this invention provides a power extension cable with loading indication and warning capable of issuing a warning message when the loading current exceeds a pre-determined warning level. Hence, a user may determine if some electrical loads should be plugged elsewhere to relieve the loading in the extension cable. Ultimately, the user is able to plug up electrical appliances more safely.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a sketch of a power extension cable with a loading indication and warning system thereon according to one preferred embodiment of this invention; and

FIG. 2 is a block diagram of the loading indication and warning system according to this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

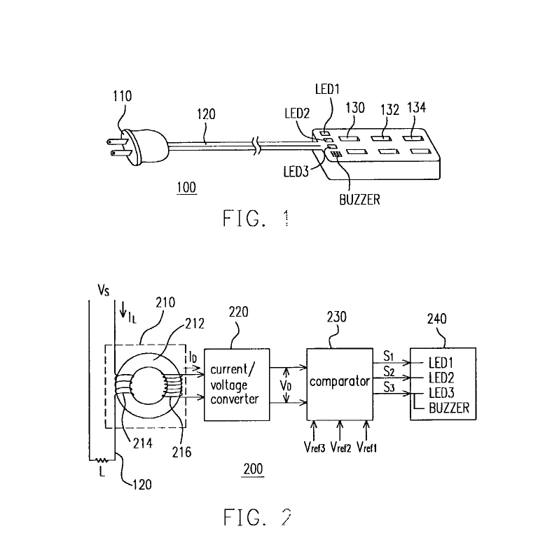

FIG. 1 is a sketch of a power extension cable with a loading indication and warning system thereon according to one preferred embodiment of this invention. FIG. 2 is a block diagram of the loading indication and warning system according to this invention. The power extension cable 100 includes a conventional power extension cable and a loading indication and warning system 200. The loading indication and warning system 200 detects size of loading current and emits a warning message such as a visual message or an acoustic message when the loading current exceeds a preset warning level.

As shown in FIG. 1, the conventional power extension cable 100 has a plug 110, a power cable 120 and a plurality of power sockets 130, 132 and 134. The plug 110 plugs into a power outlet (not shown) and the power cable 120 channels the power from the power outlet to various power sockets 130, 132 and 134 so that each of the sockets may supply a necessary loading current to a plugged electrical appliance. In addition, the range of loading current is divided into three sections whose limits are decided by a set of preset warning levels. According to the size of the loading current, the loading indication and warning system 200 determines which of the three sections the loading current belongs in and lights up light-emitting diodes LED1, LED2 and LED3 to indicate the loading level of the power extension cable 100. If the loading current is in the highest section marked out by the preset warning level, a buzzer will emit an alarm to inform a user so that the user may act accordingly. The preset warning values used for setting up various sections may be a ratio of the fixed loading current that can be supported by the power extension cable. For example, if the power extension cable 100 is able to support a maximum loading current of 12 amperes, the first light-emitting diode LED1 will light up when the loading current reaches 1 ampere. When the loading current reaches 5 amperes, the second light-emitting diode LED2 will light up. Finally, when the loading current reaches 10 amperes, the third light-emitting diode LED3 will light up and the buzzer will emit a buzzing sound at the same time. The operating principle of the loading indication and warning system 200 is further explained with reference to FIG. 2.

As shown in FIG. 2, the loading indication and warning system 200 further includes a current detector 210, a current/voltage converter 220, a comparator 230 and an alarm unit 240. The current detector 210 is made up of a primary electric coil 214 around one side of a circular iron core 212 and a secondary electric coil 216 around the other side of the circular iron core 212. The primary electric coil preferably is an extension of the power cable 120 and the number of turns in the primary electric coil 214 is smaller than the number of turns in the secondary electric coil 216. Hence, the loading current I_{L} provided by the voltage source V_{S} is converted to a monitor current I_{D} according to a ratio without affecting electrical loading L of the electrical appliances intended to be monitored. The power voltage Vs can be a 110V alternating current or a 220V alternating current depending on the type of power source the power extension cable 100 is plugged into. In general, the turn ratio of the current detector 210 is mainly determined by the required circuit design.

The current/voltage converter 220 is coupled to the current detector 210 for converting the monitor current I_{D} into a monitor voltage V_{D}. The comparator 230 is coupled to the current/voltage converter 220 for comparing the monitor voltage V_{D} with respective reference warning voltages V_{ref1}, V_{ref2} and V_{ref3}. Here, the loading current I_{L} belongs to one of three sections partitioned according to preset warning levels of 1 ampere, 5 amperes and 10 amperes. Hence, the reference voltages V_{ref1}, V_{ref2} and V_{ref3} represent a monitor voltage V_{D} under a loading current I_{L} of 1 ampere, 5 amperes and 10 amperes respectively. When the loading current I_{L} is greater than 1 ampere, the monitor voltage V_{D} is greater than the reference voltage V _{ref1}. Hence, the comparator 230 outputs a warning signal S1 to light up the light-emitting diode LED1 in the alarm unit 240. When the loading current I_{L} is greater than 5 amperes, the monitor voltage V_{D} is greater than the reference voltage V_{ref2}. Hence, the comparator 230 outputs a warning signal S2 to light up the light-emitting diode LED2 in the alarm unit 240. Finally, when the loading current I_{L} is greater than 10 amperes, the monitor voltage V_{D} is greater than the reference voltage V_{ref3}. Hence, the comparator 230 outputs a warning signal S3 to light up the light-emitting diode LED3 in the alarm unit 240 and the buzzer in the alarm unit 240 emits a sound to alarm the user at the same time.

Although three preset warning levels at 1 ampere, 5 amperes and 10 amperes are chosen for the loading current IL, actual values of the current partitioning up the sections may vary according to design. In addition, the number of preset warning levels does not have to be three. One may design an indication and warning system having the highest section at a loading current of 10 amperes so that only the third light-emitting diode LED3 lights up and/or the buzzer emits a sound.

In conclusion, major advantages of this invention include:

1. Current loading condition of the power extension cable is provided to the user at all times so that the plugging of too many electrical loads is prevented.

2. Since the current loading status of the power extension cable is always provided, users of the power extension cable may plug in electrical appliances without exceeding the operating limit. Hence, the user rarely has to reset the fuse.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A power extension cable with loading warning and indication, comprising:
a conventional power extension cable having at least a power socket to provide a loading current to an electrical load; and
a loading indication and warning system, for detecting size of the loading current and issuing a warning message when the loading current exceeds a preset warning level.

2. The power extension cable of claim 1, wherein the loading indication and warning system further includes:
a current detector for monitoring size of the loading current and outputting a monitor current;
a current/voltage converter coupled to the current detector for receiving the monitor current and converting the monitor current into a monitor voltage;
a comparator coupled to the current/voltage converter for comparing the monitor voltage with a reference voltage that represents the preset warning level and outputting a warning signal when the loading current reaches the preset warning level; and
an alarm unit coupled to the comparator for receiving the warning signal and producing a warning message.

3. The power extension cable of claim 2, wherein the current detector is made up of a primary electric coil wound around one side of an iron core and a secondary electric coil wound round the other side of the iron core.

4. The power extension cable of claim 1, wherein the warning message includes a visual message.

5. The power extension cable of claim 4, wherein the visual message is produced by a light-emitting diode.

6. The power extension cable of claim 1, wherein the warning message is an acoustic message.

7. The power extension cable of claim 6, wherein the acoustic message is produced by a buzzer.

8. The power extension cable of claim 1, wherein the preset warning level is partitioned into a few sections and a warning message is produced by a light-emitting diode in each section, and a warning message is emitted from a buzzer when the loading current reaches the highest preset warning level.

9. A loading indication and warning system for detecting loading current passing through a power extension cable and issuing a warning when the loading current exceeds a preset value, comprising:
a current detector for monitoring size of the loading current and outputting a monitor current;
a current/voltage converter coupled to the current detector for receiving the monitor current and converting the monitor current into a monitor voltage;
a comparator coupled to the current/voltage converter for comparing the monitor voltage with a reference voltage that represents the preset warning level and outputting a warning signal when the loading current reaches the preset warning level; and
an alarm unit coupled to the comparator for receiving the warning signal and producing a warning message.

10. The loading indication and warning system of claim 9, wherein the current detector is made up of a primary electric coil wound around one side of an iron core and a secondary electric coil wound round the other side of the iron core.

11. The loading indication and warning system of claim 9, wherein the warning message includes a visual message.

12. The loading indication and warning system of claim 11, wherein the visual message is produced by a light-emitting diode.

13. The loading indication and warning system of claim 9, wherein the warning message is an acoustic message.

14. The loading indication and warning system of claim 13, wherein the acoustic message is produced by a buzzer.

15. The loading indication and warning system of claim 9, wherein the preset warning level is partitioned into a few sections and a warning message is produced by a light-emitting diode in each section, and a warning message is emitted from a buzzer when the loading current reaches the highest preset warning level.
